(19) United States
(12) Patent Application Publication
(10) Pub. No.: US 2004/0246126 A1
(43) Pub. Date: Dec. 9, 2004

(54) Lost pet notification system

(76) Inventor: James Pitts, Sanford, NC (US)

Correspondence Address: Charles Y. Lackey, 1213 Forest Ridge Court, Winston-Salem, NC, 27113-5871, US

(21) Appl. No.: 10/454,324

(22) Filed: Jun. 5, 2003

(51) Int. Cl. G08B 1/08

(52) U.S. Cl. 340/539.13

(57) ABSTRACT

A satellite tracking system for use with moving objects such as animals is provided for detecting the movement and location of a moving body relative to a positional satellite. A combination transmitter/receiver (transponder) is carried by the animal for receiving and processing signals transmitted from the positional satellite. The transponder includes a satellite data receiver for detecting positional satellite data of a selected characteristic from a signal transmitted by the satellite and a transmitter responsive to the receiver for transmitting selected positional satellite data. A remotely located processing station is responsive to the selected positional satellite data received from the transmitter of the responder. The processing station includes a location detector for determining the location of the animal in response to received satellite positional data from the transmitter of the chip.

### BACKGROUND OF THE INVENTION

1. Field of the Invention

The present invention relates to animal and human tracking systems and, more particularly, to an object locating system for detecting the location of a human or an animal relative to a positional satellite which employs an implanted chip transponder.

2. Description of the Prior Art

Making sure that a pet is safe and secure is a concern for all pet owners. Keeping a pet safe and secure often requires monitoring the pet's location to make sure that the pet has not become lost. In particular, a pet owner typically needs to monitor the location of his or her pet both when the pet is left unattended, such as when the owner goes to work, or when the owner takes a pet to a public place such as a park or a walking or jogging trail. To assure the pet's safety, pet owner's have traditionally restrained their pets by keeping them within a confined area or secured by a leash. However, many pets still stray from home or run away in public places and become lost. Sometime they are stolen or kidnapped. In many cases, the pet owner may not become aware the pet is missing for an extended period of time.

Most pet owners regularly leave their pets at home when they go to work or to other places where pets are not welcome. In some cases, the pet may be left unattended for quite some time. If the pet strays from home and becomes lost while the owner is away, it may be many hours or even days before the pet owner learns that the pet has become lost. The longer the owner is unaware that the pet is missing, the more difficult it becomes to locate and retrieve the pet. A long delay in locating the pet also increases the risk of injury to the pet which often translates into greater anxiety for the owner.

Most systems currently available for locating a lost pet involve passive devices, such as dog collars imprinted with the owner's name, address and telephone number. These devices require the assistance of other individuals to locate and return the pet. Although these devices are helpful, they do not meet the pet owner's need for automatic notification when a pet strays from home or runs away.

Active pet collars have been developed to help notify passersby that a pet is lost. For example, some pet collars allow the owner to remotely activate a visual display located on the collar, such as an inflated balloon inscribed with the message “Lost Pet,” flashing lights or an electronic display. Although these systems may help to recover the pet once the owner becomes aware that the pet is missing, they do not alert the owner that the pet has been lost. As a result, the pet may be lost for an extended period of time before the owner realizes that the pet is lost and activates the visual display.

Other systems have been developed to find and retrieve lost or missing pets. For example, pet tracking systems used in hunting employ the use of radio frequency transmitters that send homing signals to portable units held by the owner. While these systems are useful once the owner begins to track his lost pet, they do not notify the owner when the pet officially becomes lost. Moreover, if the homing transmitter becomes active before the owner is ready to search for the pet, the battery in the homing transmitter may run down before the owner has a chance to complete the search.

Alarm devices have been developed for monitoring infant children in public places, such as shopping malls and fairgrounds. A harness type unit worn by the child continually transmits a signal to a handheld monitoring station carried by the parent. When the child wanders out of range, the monitoring station sounds an alarm. The parent may then remotely activate an alarm located on the child unit to alert passersby that the child is lost. Lights attached to the child unit may also assist the parent in locating the child. Although these systems are helpful in tracking lost children, they do not anticipate the needs of pet owners who leave pets unattended for hours or even days.

In applications of a location and retrieving system such as those described, the lost object signaling device is a collar, harness, belt or other items carried externally. No internal placement of such a signaling device has been found. Using an internal implanted signaling device has many advantages over prior art devices. An implanted signaling device cannot be lost or stolen. It does not impede or bother the animal in any way, and it maintains it position in the animal no matter what the situation. In addition, individuals wanting to steal an animal are not aware of the device.

From the foregoing it is obvious that there is a general need in the art for a pet monitoring system embodying a hidden or implanted signaling device that is useful when the owner leaves the pet unattended and when the owner takes the pet to a public place such as a park or a walking trail.

### SUMMARY OF THE INVENTION

A satellite tracking system for use with moving objects, such as animals and humans, is provided for detecting the movement and location of a moving body relative to a positional satellite. In the preferred embodiment, a transponder (a transmitter/receiver) is carried by an animal for receiving and processing signals transmitted from the positional satellite. For this purpose, the transponder includes a satellite data receiver for detecting positional satellite data of a selected characteristic from a signal transmitted by the satellite and a transmitter responsive to the receiver for transmitting selected positional satellite data.

A remotely located processing station is responsive to the selected positional satellite data received from the transmitter of the responder. The processing station includes a location detector for determining the location of the animal and response to received satellite positional data from the transmitter of chip.

In specific applications, an animal controller may be provided for transmitting a control signal back to the responder to enable the stimulus generator to deliver a control stimulus, such as an audible warning or a weak electrical shock to the animal. In other embodiments, the processing station may include a location indicator to display or provide a specific location of the animal. A location indicator may include an alarm for indicating satellite failure and/or to provide an indication at the remotely located processing station of the movement of the animal to or beyond selected areas.

In another embodiment, an electronic object tracking/control system employing a programmable relay unit, such as a transponder implanted chip, responsive to a positional satellite is provided for use with animals lost or requiring confinement to a limited area. In that case, a programmable relay chip is implanted within the animal at a sensitive location such as somewhere between the animal's shoulders or at some other location not accessible to the animal. Specifically, a programmable relay embedded chip is provided for the reception of satellite signals such as GPS NAVASTAR system transmissions. The embedded chip relays data to a remotely located processing station.

The remotely located processing station includes a microprocessor or microcontroller for the processing of positional satellite data required to determine the location of an animal relative to the satellite signals. Additionally, the remotely located processing station includes a data storage device for the storage of configuration files, tracking software and a receiver/transmitter for communication with the embedded relay.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a schematic diagram showing all components used in the present invention including the implantable chip, the GPS satellite system and a GPS handheld unit which serves as the remotely located processing station tracking the movement of the animal.

### DETAILED DESCRIPTION OF THE PREFERRED EMBODIMENT

Referring now to the drawing, a lost object notification system shown generally as 10 is provided for tracking the movement of animals, humans and other moving objects. A programmable relay embedded chip 12 emits, at a variable preset rate, high frequency transmissions of positional data as detected from signals of positional satellites 14 to a remotely located processing station 16. Processing station 16 calculates the relayed data to determine the position and ground speed of the object relative to a configuration data file. Chip 12 is implanted under the skin, for example, between the shoulders of dogs, horses, cattle or wildlife. The processing station here will be a GPS handheld device which sends a high frequency signal to implanted chip 12. Implanted chip 12 receives and relays the signal to positional satellites 14 who then return the signal with GPS coordinates of the animal to the implanted chip 12. Chip 12 then sends the GPS coordinates to handheld device 16.

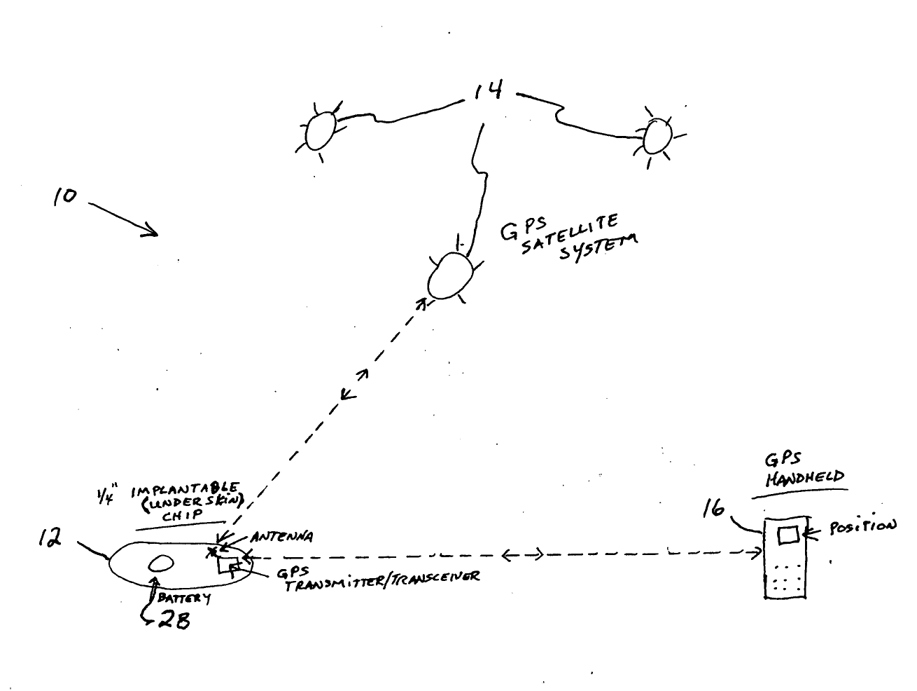

The programmable electronic tracking system constituting the present invention is designed primarily for tracking the movement of an animal, such as a dog, relative to a selected location. In broader applications, the system may be used to track movement and location of an object anywhere relative to the positional data from the satellite. As such, both positional location and directional speed of movement can be detected and tracked. As shown in FIG. 1, a group of positional satellites 14 such as the GPS system (Global Positioning System), cooperatively function with a programmable chip 12 implanted under the skin of the animal and a remotely located data processing center 16 are operably linked to provide an alarm indicating a satellite system failure. The alarm of processing center 16 is either audible or visual and may be performed by an appropriately interfaced automation system.

As an example, a dog 24 is equipped with a programmable embedded chip which includes detection circuitry and transmission circuitry, preferably supported by a battery 28. The reception circuitry detects signals from positional satellites 14 signals and remotely located processing station 16. The transmission circuitry relays positional satellite data to the receiver of chip 12 and then from transmitter of chip 12 to the remotely located processing station 16. Positional satellites 14 radiate precise positional information to embedded chip 14.

If the distance between a relay embedded chip relative to the three positional satellites is known, the chip can be located on the surface of the earth utilizing the three dimensional Pythagorean theorem. The distance from the chip to the positional satellites is determined by calculating the time between a satellite signal broadcast and chip reception. Each positional satellite signal includes a unique pseudo noise sequence so that the receiver can differentiate between various satellites and account for their specific orbital movement.

This positional information is relayed at a variable or preset rate by chip 12 at a selected frequency to processing station 16. The frequency of the signal transmitted by the relay collar to the processing station is lower than the frequency the signal received by the collar from the satellite. Processing station 16 determines the location and ground speed of the animal equipped with implanted chip 12.

There are numerous advantages in using a implanted chip. They include the following:

(1) The product will only be limited by the ability to find a GPS satellite anywhere in the world. In most cases the maximum range will be 100 miles. Most current products have a maximum range of no more than 0.25 miles, and the most common implanted pet identification product only has a range of a few inches.

(2) This product will give the location by longitude and latitude in numerical format as defined by the GPS standard. There is currently no universal standard for pet identification products that are implanted, therefore multiple types of equipment are needed to read the information.

(3) The numerical system (1, 2, 3 . . . ) is recognized almost worldwide, so this product can be used by anyone, anywhere. Moreover, the product can be used by someone who lost a pet while traveling in any country throughout the world. Other products are language-based which means that the pet needs to be found by someone that can read that particular language or that has a translator.

(4) This product puts the control of finding the lost animal in the hands of the owner. Other products depend upon someone else locating the animal. An animal is many times unable to be found with other products, because they are afraid and lost in inaccessible areas such as large forests, cities and the like. Other products require someone having the animal in their possession. With this product, the owner can locate his animal on his own, anywhere and anytime day or night.

(5) Each produced product (implanted and handheld pair) has a unique frequency and encryptors which will keep them from interfering with each other and loosing their privacy.

(6) The product is implanted beneath the skin so that it cannot be removed by a person trying to steal the animal, removed by the animal itself while moving over rough terrain or impacted by bad weather. The implantation would most likely reside above the shoulders to be accessible to satellite communication and will be held in place, under the skin, by a chemical coating on the chip to prevent movement within the animal.

(7) The imbedded GPS transceiver chip and battery will be small and light enough to be implanted very small pets.

(8) The portable processor station will be a small and lightweight handheld unit weighing about one pound.

In summary, the present invention includes the animal owner having a handheld GPS device 16 to activate when the animal's location is desired. By that activation, GPS device 16 sends a high frequency signal to chip 12, and the transmitter component of chip 12 passes on the signal to positional satellites 14. Positional satellites 14 return the GPS coordinates to the receiver component of chip 12, and these coordinates are then sent to GPS device 14.

Thus it can be seen that an improvement for locating lost objects has been provided that will meet all the advantages of prior art devices and offer additional advantages not heretofore achievable. With respect to the present invention, the optimum dimensional relationship to the parts of the invention include variations in size, materials, shape, form, function and manner of operation, used in the product are deemed readily apparent to those skilled in the art, and all equivalent relationships illustrated in the drawings and used and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. An animal locating system for detecting the location of an animal relative to a positional satellite, the system comprising: an implanted chip transponder carried by the animal capable of receiving positional satellite data of a selected characteristic; a transmitter responsive to the transponder to re-transmit selected positional satellite data; control means responsive to the selected positional satellite data from the transmitter including a location detector for determining the change in location of the animal in response to the selected satellite positional data from the transmitter and an animal speed monitor for updating the retransmission rate of the transmitter relative to the change in location by the animal.

2. An animal locating system for detecting the location of an animal relative to a positional satellite, the system comprising: an implanted chip transponder for receiving and processing signals from the positional satellite, the transponder including a satellite data receiver for detecting positional satellite data and a transmitter responsive to the receiver for retransmitting selected positional satellite data; and a remotely located processing station responsive to the selected positional satellite data received from the responder transmitter, the station including a location detector for determining the location of the animal in response to the received positional satellite data.

2. A method for detecting the location of an animal relative to a positional satellite comprising the steps of: detecting positional satellite data of a selected characteristic using an implanted chip transponder having a satellite data receiver; re-transmitting selected positional satellite data using a transmitter responsive to the receiver; and determining the change in location of the animal in response to the selected satellite positional data from the transmitter and an animal speed monitor for updating the re-transmission rate of the transmitter relative to the change in location by the animal.

4. The system as claimed in claim 1 wherein the processing station includes a location indicator to display a specific location of the animal.

5. The system as claimed in claim 2 wherein the processing station includes a location indicator to display a specific location of the animal.

6. The method as claimed in claim 3 further comprising the step of: viewing the specific location of the animal via a location indicator.

7. The system as claimed in claim 1 wherein the processing station is handheld.

8. The system as claimed in claim 2 wherein the processing station is handheld.

9. The system as claimed in claim 1 wherein the processing station includes a battery charger.

10. The system as claimed in claim 2 wherein the processing station includes a battery charger.
